(19) United States
(12) Patent Application Publication
(10) Pub. No.: US 2024/0116111 A1
(43) Pub. Date: Apr. 11, 2024

(54) METHOD FOR PREVENTING DAMAGES DUE TO RESONANCE DURING THE CLEANING OF AN AT LEAST PARTIALLY ADDITIVELY MANUFACTURED COMPONENT, AND CLEANING DEVICE

(71) Applicant: MTU Aero Engines AG, München (DE)

(72) Inventor: Kaspar Wolf, Munich (DE)

(73) Assignee: MTU Aero Engines AG, München (DE)

(21) Appl. No.: 18/264,516

(22) PCT Filed: Jan. 27, 2022
(86) PCT No.: PCT/DE2022/100071

§ 371 Date: Aug. 7, 2023

(30) Foreign Application Priority Data
Feb. 9, 2021 (DE) 10 2021 201 170.5

(51) Int. Cl. B22F 10/68; B08B 7/02; B08B 13/00; B29C 64/35; B33Y 30/00; B33Y 40/20

(52) U.S. Cl. CPC B22F 10/68; B08B 7/02; B08B 13/00; B29C 64/35; B33Y 30/00; B33Y 40/20

(57) ABSTRACT

The invention is directed to a method for cleaning a component from powder residues of an additive layering method using a cleaning device, wherein a machine plate and the component arranged thereon are excited during a cleaning process by a vibration actuator of the cleaning device with a set resonance frequency of the machine plate to carry out a mechanical vibration. It is provided that the machine plate is excited by predefined vibration movements of the at least one vibration actuator to the predefined mechanical vibration, wherein the predefined vibration movements of the at least one vibration actuator occur in parallel to a main plane of the machine plate. The invention also relates to a cleaning device for cleaning an at least partially additively manufactured component, in particular a component of a turbomachine.

### BACKGROUND OF THE INVENTION

Additive layer construction processes are processes in which geometric data are determined with the aid of a virtual model of a component or a region of a component being manufactured, and are broken up into layer data (so-called “slices”). Depending on the geometry of the model, a light-exposure or radiation-exposure strategy is determined, whereby the selective solidification of a material should result. In the layer construction process, the desired material is then laid down layer by layer and selectively scanned and solidified by means of an energy beam in order to build up the component additively, layer by layer. Various radiation exposure parameters such as the energy beam power and the light exposure speed of an energy beam being used for the solidification are important to the resulting textural structure. In addition, the arrangement of so-called scan lines is also important. The scan lines, which can also be called single tracks, melting tracks, or exposure vectors, define the areas along which the at least one energy beam scans and melts the material, and these lines may generally run in linear or non-linear fashion. Thus, additive or generative manufacturing methods differ from conventional material removal or primary manufacturing methods. Examples of additive manufacturing methods are generative laser sintering or laser melting methods, which can be used, for example, for the manufacturing of components for turbomachines such as aircraft engines. In selective laser melting, thin powder layers of the material or the materials being used are placed on a construction platform and melted and solidified with the aid of one or more laser beams locally in the region of a building-up or joining zone. After this, the construction platform is lowered, a further powder layer is applied, and once again a local solidification occurs. This cycle is repeated until the finished component or the finished component region is obtained. The component can then be further machined, if necessary, or used with no further machining steps. In selective laser sintering, the component is produced in similar manner by laser-supported sintering of powderlike materials. The supplying of the energy in this case, for example, comes from laser beams of a CO₂ laser, Nd:YAG laser, Yb-fiber layer, diode laser, or the like. Also known are electron beam methods in which the material is selectively scanned and solidified by one or more electron beams.

In additive layer construction processes in which the material is applied as a powder, unmelted powder residue may be clinging to an at least partially additively manufactured component. For this reason, it is essential to clean the powder residue from the at least partially additively manufactured component after the completion of the layer construction process. This can be done manually, for example, by means of a pressurized air blower. The manual cleaning of additively manufactured components has the drawback, however, of involving a large time expenditure, which may lead to increased costs of the manufactured components, especially in the case of mass production.

In to make possible a higher degree of automation in the manufacturing of components by means of additive layer construction processes, it is therefore common practice to clean the powder residue from the manufactured components by means of cleaning devices. These cleaning devices excite the manufactured component to produce vibrations by which the powder residue clinging to the component is loosened. The powder residue is usually collected in a catching apparatus of the cleaning device in order to be used for later additive manufacturing processes. The cleaning processes can be carried out in airtight protective chambers, so that it is possible to prevent the spread of dust harmful to health in the surroundings. It is also possible to fill these protective chambers with a predefined atmospheric gas in order to prevent reactions in the case of reactive powders.

One problem with cleaning processes by cleaning devices occurs in the excitation of the component to produce vibrations. The vibrations are generally excited by placing a machine plate in oscillation, having the component arranged thereon, by a vibration actuator, which is usually configured as an imbalance producer. The imbalance producer comprises an imbalance element, which is rotated about an axis of rotation oriented parallel to a main plane of the machine plate. In the case of a horizontally oriented machine plate, forces acting vertically on the attack surface of the vibration actuator are transmitted to the machine plate. In this way, especially when the machine plates are mounted on one side, the vertical forces may produce a leverage, which can excite bending and/or torsional modes in the machine plate. Damage can be produced in the component due to the deflections and/or stresses produced in this way.

In CN 210190613 U a printing platform is disclosed, which is adapted to mount a 3-D printer in stabilized manner.

In WO 2019/009905 A1 there is disclosed a device for additive manufacturing. The device comprises a vibrating bed, on which a volume of building material can be arranged. The bed can be placed in vibration in order to remove excess building material. A nonvibrating frame of the device braces the vibrating bed. The device has an interface between the bed and a frame, in order to stow the vibrating bed with the nonvibrating bed frame and isolate vibrations from the vibrating bed.

### SUMMARY OF THE INVENTION

An object of the invention is to reduce the extent of bending and torsional modes in vibration-based cleaning processes.

The invention relates to a method for preventing damage due to resonance during the cleaning of powder residue in an additive layer construction process from an at least partially additively manufactured component by a cleaning device. The component can be, in particular, a component of a turbomachine. The powder residue may contain metallic and/or non-metallic portions. In the method, it is proposed that a machine plate and the at least partially additively manufactured component arranged thereon are excited to produce a predefined mechanical vibration during a cleaning process by a vibration actuator of the cleaning device, in order to loosen the powder residue from the at least partially additively manufactured component. In other words, it is proposed that the at least partially additively manufactured component on which the powder residue is present is arranged on a machine plate of the cleaning device. The arrangement may involve, for example, a clamping, tensioning, or screwing of the component on the machine plate. In order to make possible the loosening of the powder residue from the component, the machine plate is excited to produce an oscillation which is transferred to the component. For this purpose, the machine plate is excited by the vibration actuator of the cleaning device to produce the predefined mechanical vibration. The machine plate of the cleaning device and the at least partially additively manufactured component arranged thereon are swiveled during the predefined cleaning process by a swiveling apparatus of the cleaning device about at least one axis in order to make possible a flowing off of the powder residue from the at least partially additively manufactured component. In other words, it is provided that the machine plate is arranged on the swiveling device by which the machine plate is swiveled during the cleaning process. Due to the swiveling, the machine plate with the at least partially additively manufactured component arranged thereon rotates about one or more axes. The swiveling process can include swiveling with predefined swiveling movements, which may depend, for example, on the geometry of the component. In this way, it may be possible to enable a flowing off of the powder residue from the at least partially additively manufactured component by also enabling a flowing out of the powder residue from openings and/or ducts of the component.

It is proposed that the machine plate is excited to produce the predefined mechanical vibration by predefined vibrational movements of the at least one vibration actuator, the predefined vibrational movements of the at least one vibration actuator occurring parallel to a main plane of the machine plate. In other words, it is proposed that the machine plate is excited by the at least one vibration actuator to produce an oscillation, wherein the vibrational movements of the vibration actuator occur parallel to the main plane of the machine plate. In other words, the vibrational movements and/or the vibrational forces provided by the at least one vibration actuator have no components oriented perpendicular to the main plane of the machine plate. For example, it can be provided that the at least one vibration actuator is a linear imbalance vibration actuator, making an imbalance weight oscillate in linear manner parallel to the main plane of the machine plate. The imbalance of the vibration produced in this way thus acts parallel to the main plane of the machine plate. Alternatively, it can be provided that the vibration actuator is designed as a rotation imbalance vibration actuator and that it rotates the imbalance weight about an axis of rotation of the vibration actuator, the axis of rotation being oriented perpendicular to the main plane of the machine plate. In this way, the forces produced by the vibration actuator also act only parallel to the main plane of the machine plate. The invention affords the benefit that the dominant excitation occurs in the main plane of the machine plate and thus bending and/or torsional modes in the machine plate are reduced when compared to the plate modes within the main plane.

One further development of the invention calls for the machine plate to be excited on an attack surface of the at least one vibration actuator which is oriented parallel to the main plane of the machine plate. In other words, the at least one vibration actuator is arranged on the machine plate such that the forces produced by the vibration actuator engage with the attack surface, which is oriented parallel to the main plane of the machine plate. For example, it may be provided that the vibration actuator is arranged on a top side or a bottom side of the machine plate. The top and bottom sides of the machine plate can be oriented parallel to the main plane of the machine plate. Because the vibration actuator is arranged on the top or bottom side oriented parallel to the main plane, the contact surface forms the attack surface parallel to the main plane of the machine plate.

A further development of the invention calls for the machine plate to be excited on an attack surface of the at least one vibration actuator which is oriented perpendicular to the main plane of the machine plate. In other words, it is provided that the force which is produced by the at least one vibration actuator is transmitted to the machine plate at the attack surface situated perpendicular to the main plane of the machine plate. For example, it can be provided that the machine plate is excited by the vibration actuator to produce an oscillation at a side surface of the machine plate. In this case, the vibration actuator can be arranged on the vertical side surface. The side surface can run perpendicular to the main plane of the machine plate.

A further development of the invention calls for the machine plate to be excited on at least two attack surfaces of the respective vibration actuators. In other words, the excitation of the machine plate occurs by at least two vibration actuators, which produce the oscillation of the machine plate at respective attack surfaces.

A further development of the invention calls for the machine plate to be excited on at least two oppositely situated attack surfaces of the respective vibration actuators. For example, it can be provided that the two vibration actuators are arranged on the machine plate, the attack surfaces being situated on opposite side surfaces. It can be provided that a first one of the attack surfaces is arranged on the top side of the machine plate and a second one of the attack surfaces is arranged opposite it on the bottom side of the machine plate. This affords the benefit that lever components can be canceled out during the excitation. In other words, a leverage produced by a transmission of force at one of the attack surfaces in the machine plate can be canceled out by an oppositely acting leverage which is produced by the transmission of force at the other attack surface in the machine plate. It can be preferably provided for this that the attack surfaces have the identical distance from a center of the machine plate.

The invention also comprises a cleaning device for the cleaning of powder residue of an additive layer construction process from an at least partially additively produced component, especially a component of a turbomachine. The cleaning device is designed:
to excite a machine plate and the at least partially additively manufactured component arranged thereon to produce a predefined mechanical vibration during a cleaning process by at least one vibration actuator of the cleaning device in order to loosen the powder residue from the at least partially additively manufactured component and to swivel the machine plate of the cleaning device and the at least partially additively manufactured component arranged thereon about at least one axis during the predefined cleaning process by a swiveling apparatus of the cleaning device in order to allow a flowing off of the powder residue from the at least partially additively manufactured component. It is proposed that the machine plate is excited to produce the predefined mechanical vibration by predefined vibrational movements of the at least one vibration actuator, wherein the predefined vibrational movements of the at least one vibration actuator occur parallel to a main plane of the machine plate.

### BRIEF DESCRIPTION OF THE DRAWING FIGURES

Further features of the invention will emerge from the claims, the figures, and the description of the figures. The features and combinations of features mentioned in the above description, as well as those mentioned in the following description of the figures and/or shown only in the figures, may be used not only in the particular indicated combination, but also in other combinations, without leaving the scope of the invention. Thus, embodiments of the invention not explicitly shown or explained in the figures, yet which derive from and can be created by separate combinations of features from the explained embodiments, are to be considered as being disclosed and encompassed by the invention. Thus, embodiments and combinations of features which do not contain all the features of an originally worded independent claim are also to be viewed as being disclosed. Furthermore, embodiments and combinations of features which go beyond or deviate from the combinations of features presented in the back references of the claims are to be viewed as being disclosed, especially by the embodiments presented above. Shown herein are:

FIG. 1, a schematic representation of a cleaning device according to the prior art;

FIG. 2, a schematic representation of a cleaning device according to the invention;

FIG. 3, a schematic representation of a cleaning device according to the invention in another embodiment; and

FIG. 4, modes forming in a machine plate.

### DESCRIPTION OF THE INVENTION

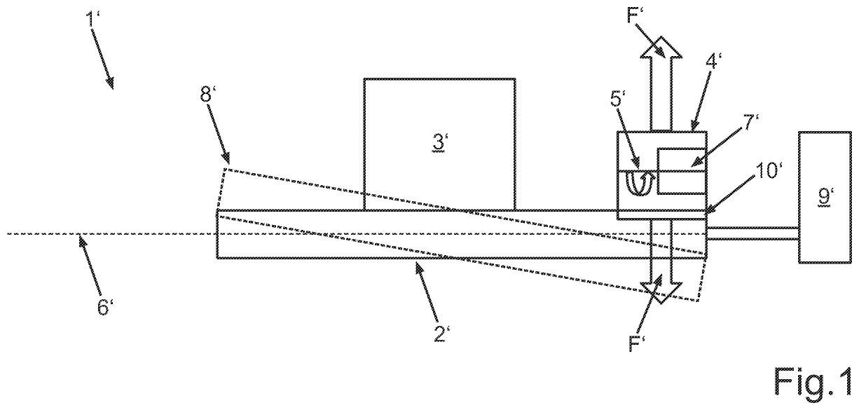

FIG. 1 shows a cleaning device 1′ of the prior art. The cleaning device 1′ of the prior art can comprise a machine plate 2, on which an at least partially additively manufactured component 3′ can be arranged. The arrangement can be made, for example, by screwing, clamping, or tensioning of the component 3′ in the machine plate 2′. In order to clean powder residue from the component 3′, it can be provided that the cleaning device 1′ has a vibration actuator 4′, which can be adapted to excite the machine plate 2′ with a predefined frequency to bring about an oscillation of the machine plate 2′, which is transmitted to the component 3′. The vibration actuator 4′ is arranged on a top side of the machine plate 2′ and has a common contact surface with the machine plate 2′, which can be the attack surface 10′ at which the vibrations and forces of the vibration actuator 4′ can be transmitted to the machine plate 2′. It can be provided that the excitation of the machine plate 2′ by the vibration actuator 4′ occurs with a resonance frequency of the machine plate 2′ in order to achieve the greatest possible amplitude. The resonance frequency of the machine plate 2′ may be dependent on the material and/or the geometry of the machine plate 2′, so that this can be given in advance. The vibration actuator 4′ can be designed, for example, as a rotation imbalance vibration actuator and have an axis of rotation 5′ oriented parallel to a main plane 6′ of the machine plate 2′. The main plane 6′ lies parallel to the surface of the machine plate 2′ having the greatest extension. The surface with the greatest extension can be, in particular, that of the top and/or the bottom side(s) of the machine plate 2′. An imbalance element 7′ can rotate about the axis of rotation 5′, thereby producing vibrations. The forces F′ produced in this way act in directions parallel to a normal plane of the axis of rotation 5′. In this way, forces F′ are exerted by the rotation imbalance vibration actuator 4′ which may have components transverse to the main plane 6′. In the case of a horizontally oriented machine plate 2′, these act in the vertical direction and are thus perpendicular to the main plane 6′ of the machine plate 2′. This can produce a leverage 8 ‘and bending and/or torsional modes may be formed in the machine plate 2’. In this way, the excitation may produce pronounced amplitudes in the vertical direction in the machine plate 2′, which may damage the component 3′. The cleaning device 1′ may have a swiveling device 9′, which can be adapted to swivel the machine plate 2′ and the at least partially additively manufactured component 3′ arranged thereon by a swiveling about at least one axis during the predefined cleaning process to enable a flowing out of the powder residue from openings of the component 3′.

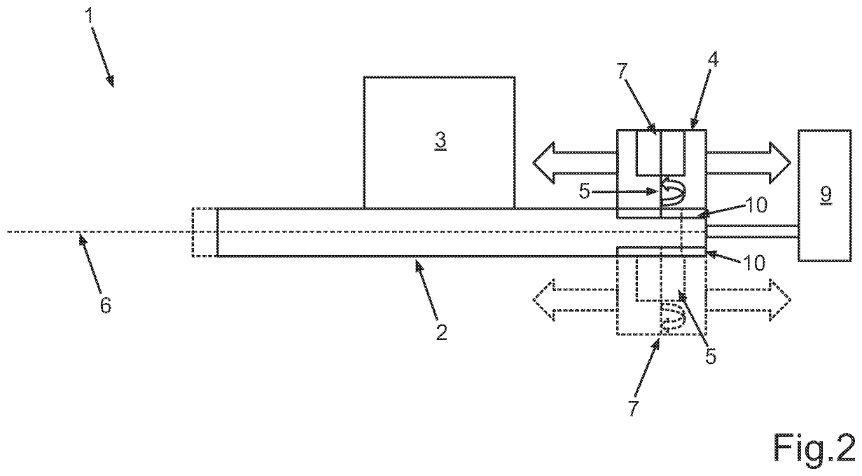

FIG. 2 shows a cleaning device 1. A run of the method will also be explained with the aid of the cleaning device 1 shown. In the represented cleaning device 1, the vibration actuator 4 is likewise arranged on a top side of the machine plate 2. The attack surface 10 is likewise located parallel to the main plane 6 of the machine plate 2. The axis of rotation 5 of the vibration actuator 4, however, is oriented perpendicular to the main plane 6, so that the forces F produced by the rotation of the imbalance element 7 act parallel to the main plane 6. In this way, vibrations within the main plane 6 are dominant and vibration components transverse to the main plane 6 are reduced when compared to the configuration of the prior art as shown in FIG. 1. In order to further reduce the leverage, it can be provided to arrange another vibration actuator 4 on an opposite bottom side of the machine plate 2, so that the attack surfaces 10 of the respective vibration actuators 4 are situated opposite each other. In this way, oppositely acting lever arms can be canceled out, so that the amplitudes of the bending and torsional modes can be further reduced.

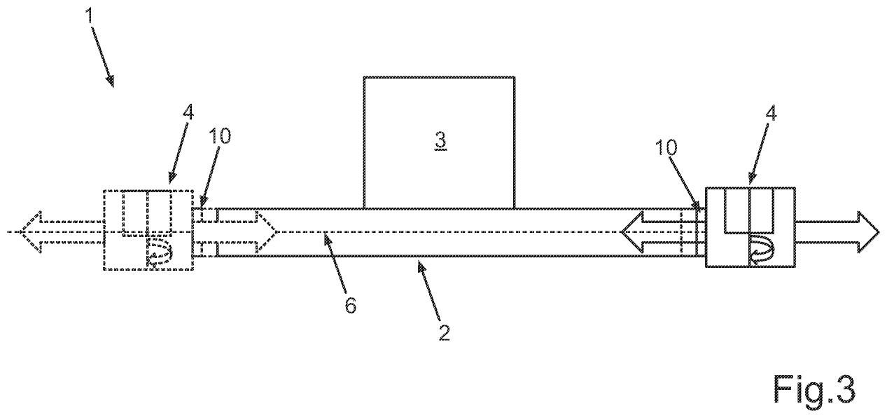

FIG. 3 shows another embodiment of the cleaning device 1. The attack surfaces 10 can be arranged perpendicular to the main plane 6 and lie, for example, against a secondary surface of the machine plate 2. The vibration actuators 4 can likewise be designed as rotation imbalance vibration actuators, and their axes of rotation 5 can likewise be oriented perpendicular to the main plane 6. The vibration actuators 4 can thereby produce forces F which are oriented parallel to the main plane 6. If the at least one attack surface 10 is arranged such that it is divided in its middle by the main plane 6, the forces F will produce no resultant lever arm, so that the bending and/or torsional modes are minimized.

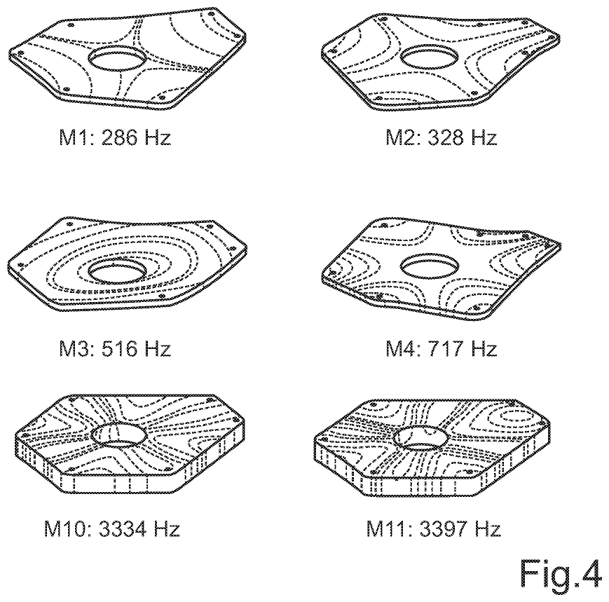

FIG. 4 shows the modes forming in a machine plate 2. The first two rows show the amplitudes of the torsional and bending modes in the machine plate 2. The last row shows the amplitudes of the plate modes in the machine plate 2.

1. A method for preventing damages due to resonance during a cleaning of an at least partially additively manufactured component from powder residues of an additive layer construction process by a cleaning device, wherein
a machine plate and the at least partially additively manufactured component arranged thereon are excited during a cleaning process by at least one vibration actuator of the cleaning device to a predefined mechanical vibration in order to loosen the powder residue from the at least partially additively manufactured component, and
the machine plate of the cleaning device and the at least partially additively manufactured component arranged thereon are swiveled during the predefined cleaning process by a swiveling apparatus of the cleaning device about at least one axis in order to make possible a flowing off of the powder residue from the at least partially additively manufactured component,
wherein the machine plate is excited to the predefined mechanical vibration by predefined vibrational movements of the at least one vibration actuator, wherein the predefined vibrational movements of the at least one vibration actuator occur parallel to a main plane of the machine plate.

2. The method according to claim 1, wherein the machine plate is excited on an attack surface of the at least one vibration actuator which is oriented parallel to the main plane of the machine plate.

3. The method according to claim 1, wherein the machine plate is excited on an attack surface of the at least one vibration actuator which is oriented perpendicular to the main plane of the machine plate.

4. The method according to claim 2, wherein the machine plate is excited on at least two attack surfaces of the respective vibration actuators.

5. The method according to claim 4, wherein the machine plate is excited on at least two oppositely situated attack surfaces of the respective vibration actuators.

6. A cleaning device for the cleaning of an at least partially additively manufactured component from powder residues of an additive layer construction process, wherein the cleaning device is configured and arranged to
excite a machine plate and the at least partially additively manufactured component arranged thereon during a cleaning process by at least one vibration actuator of the cleaning device to a predefined mechanical vibration in order to loosen the powder residue from the at least partially additively manufactured component, and
swivel the machine plate of the cleaning device and the at least partially additively manufactured component arranged thereon about at least one axis during the predefined cleaning process by a swiveling apparatus of the cleaning device in order to enable a flowing off of the powder residue from the at least partially additively manufactured component,
wherein the cleaning device is configured and arranged to excite the machine plate to the predefined mechanical vibration by predefined vibrational movements of the at least one vibration actuator, wherein the predefined vibrational movements of the at least one vibration actuator occur parallel to a main plane of the machine plate.

7. The method according to claim 1, wherein the at least partially additively manufactured component is a component of a turbomachine.

8. The method according to claim 3, wherein the machine plate is excited on at least two attack surfaces of the respective vibration actuators.

9. The method according to claim 8, wherein the machine plate is excited on at least two oppositely situated attack surfaces of the respective vibration actuators.

10. The cleaning device according to claim 6, wherein the at least partially additively manufactured component is a component of a turbomachine.
